(19) United States
(12) Patent Application Publication
(10) Pub. No.: US 2022/0140575 A1
(43) Pub. Date: May 5, 2022

(54) SPARK PLUG INSULATOR AND METHOD OF MAKING SAME

(71) Applicant: FEDERAL-MOGUL IGNITION LLC, Southfield, MI (US)

(72) Inventors: William J. Walker, JR., Ann Arbor, MI (US); Michael E. Saccoccia, Canton, MI (US)

(21) Appl. No.: 17/490,613

(22) Filed: Sep. 30, 2021

Related U.S. Application Data
(60) Provisional application No. 63/107,600, filed on Oct. 30, 2020.

(51) Int. Cl. H01T 13/38; H01T 21/02; H01B 3/12; H01B 19/00

(52) U.S. Cl. CPC H01T 13/38; H01B 19/00; H01B 3/12; H01T 21/02

(57) ABSTRACT

A spark plug insulator comprising a ceramic body with a photopolymerized and sintered microstructure. The spark plug insulator can have one or more complex geometries, such as dual axial bores, channels or grooves for wiring or the like, or internal wells. In one embodiment, an internal well is situated in the nose portion of the axial bore. The internal well has a terminal end, a base, and a ceramic bounding ring that is diametrically reduced with respect to a diameter at the base of the internal well. In some embodiments, there is a center electrode shield portion adjacent the internal well, where a diameter of the center electrode shield portion is diametrically reduced with respect to the diameter at the base of the internal well.

### FIELD

This disclosure generally relates to spark plug insulators and, more particularly, to spark plug insulators having a ceramic body with a photopolymerized and sintered microstructure.

### BACKGROUND

The insulator of a spark plug includes a number of features that facilitate various performance attributes. In some embodiments, for example, the core nose portion of the insulator includes one or more wells to improve the spark plug's performance when carbon fouling occurs. In another example, the insulator may have dual internal bores to accommodate two center electrodes and form a spark plug having two distinct spark gaps. In yet another example, the spark plug insulator includes grooves or channels to accommodate wires of a thermocouple to measure combustion temperature. Sensing various engine conditions while an engine is running can be an important tool for understanding engine performance, diagnosing engine problems, and developing the appropriate spark plug and spark plug firing conditions for a particular engine. Commonly, temperature is measured in an internal combustion engine with a thermocouple spark plug which includes partially or fully embedded thermocouple wires in the ceramic insulator of the spark plug. The tooling involved in manufacturing these example insulators, such as finned or other specialized shaping arbors, can be expensive and the insulator body is oftentimes broken or damaged during manufacturing processes because of the close tolerances required.

### SUMMARY

In accordance with one embodiment, there is a spark plug insulator comprising a ceramic body. The ceramic body comprises an axial bore and a photopolymerized and sintered microstructure surrounding the axial bore.

In some embodiments, the ceramic body comprises a nose portion, an intermediate portion, a terminal portion, with the axial bore extending from a distal end at the nose portion to a terminal end. The ceramic body further comprises an internal well in the nose portion of the axial bore. The internal well has a terminal end, a base, and a ceramic bounding ring. The ceramic bounding ring is diametrically reduced with respect to a diameter at the base of the internal well, and the ceramic bounding ring is situated between the terminal end of the internal well and the distal end at the nose portion.

In some embodiments, the internal well has a spherical geometry.

In some embodiments, the base of the internal well has a circular cylindrical geometry.

In some embodiments, the ceramic body includes a center electrode shield portion adjacent the internal well, wherein a diameter of the center electrode shield portion is less than or equal to the diameter at the base of the internal well.

In some embodiments, the ceramic body includes an internal step portion adjacent the center electrode shield portion, wherein the internal step portion separates the nose portion from the intermediate portion of the body, and the diameter of the center electrode shield portion is less than or equal to a diameter at the intermediate portion.

In some embodiments, the ceramic bounding ring is a projecting rib with a shielding surface.

In some embodiments, there are one or more additional internal wells that create an undulating pattern with the internal well.

In some embodiments, the ceramic body has less than 2% by volume porosity.

In some embodiments, the photopolymerized and sintered microstructure has a plurality of layers built in a substantially longitudinal direction or a substantially transverse direction.

In some embodiments, the photopolymerized and sintered microstructure has a plurality of layers built in a direction that is substantially perpendicular to an axis A of the spark plug insulator.

In some embodiments, the ceramic body has a second axial bore, with each axial bore being configured to accommodate a center electrode.

In some embodiments, the ceramic body has one or more channels configured to accommodate one or more wires.

In accordance with another embodiment, there is provided a spark plug insulator comprising a body having a nose portion, an intermediate portion, and a terminal portion. The body has an axial bore extending through the body from a distal end at the nose portion to a terminal end at the terminal portion. The axial bore includes an opening portion adjacent the distal end and an internal well adjacent the opening portion. The internal well has a ceramic bounding ring, a terminal end, and a base, the ceramic bounding ring is diametrically reduced with respect to a diameter at the base of the internal well. The ceramic bounding ring is situated between the terminal end of the internal well and the opening portion. The axial bore further includes a center electrode shield portion adjacent the internal well. A diameter of the center electrode shield portion is less than or equal to a diameter of the base of the internal well. The axial bore further includes an internal step portion adjacent the center electrode shield portion. The internal step portion separates the nose portion from the intermediate portion of the body.

In some embodiments, the body is a ceramic body having a photopolymerized and sintered microstructure.

In some embodiments, the diameter of the center electrode shield portion is less than or equal to a diameter at the opening portion, and wherein the diameter of the center electrode shield portion is less than or equal to a diameter at the intermediate portion.

In accordance with another embodiment, there is provided a method of making an insulator for a spark plug. The method includes directing light from a light source at a precursor ceramic slurry, and creating an insulator layer. The insulator layer includes a portion of a photopolymerized ceramic body surrounding a portion of an axial bore.

In some embodiments, the method includes moving a stage to expose additional precursor ceramic slurry to the light source to create additional insulator layers.

In some embodiments, the light source is a laser, and the insulator layer includes a sideways spherical volume buildup to create an overhang.

Various aspects, embodiments, examples, steps, features and alternatives set forth in the preceding paragraphs, in the claims, and/or in the following description and drawings may be taken independently or in any combination thereof. For example, features or steps disclosed in connection with one embodiment are applicable to all embodiments in the absence of incompatibility of features.

### DRAWINGS

Preferred example embodiments will hereinafter be described in conjunction with the appended drawings, wherein like designations denote like elements, and wherein:

FIG. 1 is a cross-sectional view of a condition sensing spark plug according to one embodiment;

FIG. 2 is a cross-sectional view of an example insulator for a condition sensing spark plug;

FIG. 3 is a partial, cross-sectional view of the insulator of FIG. 2 taken along line 3-3 in FIG. 2;

FIG. 4 is a flowchart illustrating steps of manufacturing a spark plug insulator, such as the insulator shown in FIGS. 1-3;

FIG. 5 schematically illustrates one embodiment of a method of manufacturing an insulator;

FIG. 6 schematically illustrates another embodiment of a method of manufacturing an insulator;

FIG. 7 is a perspective view of a portion of an insulator;

FIG. 8 is another perspective view of another portion of an insulator, built on the portion shown in FIG. 7;

FIG. 9 is another perspective view of an insulator, built on the insulator portions shown in FIGS. 7 and 8;

FIG. 10 illustrates the microstructure of a spark plug insulator formed from an isostatic pressing method;

FIG. 11 illustrates the microstructure of a spark plug insulator formed from the methods described herein;

FIG. 12 illustrates another embodiment of an insulator with an enlarged schematic view of its microstructure;

FIG. 13 shows a firing end of an insulator having a well according to one embodiment;

FIG. 14 shows a firing end of an insulator having a well according to another embodiment;

FIG. 15 shows a firing end of an insulator having a well according to yet another embodiment; and

FIG. 16 shows a firing end of an insulator having a plurality of wells according to one embodiment.

### DESCRIPTION

The methods described herein may be used to make an insulator for a spark plug, and are described within the context of a condition sensing spark plug, such as a thermocouple spark plug, as well as within the context of a dual barrel spark plug and a spark plug having one or more internal wells located at the distal or firing end. The spark plug insulator has a ceramic body, which has a very fine, photopolymerized and sintered microstructure, as opposed to pressed insulators or the like. To create the ceramic body, light from a light source is directed to a ceramic slurry including polymerizable organic resins. This stereolithography method forms a green ceramic insulator from the ceramic slurry that can be precisely shaped according to varying geometries. In particular, detailed features such as internal wells and thermocouple wire channels can be more precisely and efficiently formed.

While the disclosure relates primarily to a thermocouple-based, condition sensing spark plug, along with a dual barrel plug and a plug having internal wells located in the axial bore of the insulator, many aspects are also applicable to other spark plug types and configurations. In many condition sensing spark plugs, a thermocouple or other sensor is located on the outer surface of an insulator nose so that it is exposed to a combustion chamber and can take readings therein. The readings or other data are transmitted back to some type of sensing, display, or processing device through one or more wires embedded in channels extending in the insulator. Some conventional methods for making insulators having these wire receiving channels utilize a process of forming an unfired insulator body around a special shaping arbor. However, particularly with the use of high alumina-based ceramic compositions, removal of the shaping arbor can crack or otherwise damage the insulator because of very thin fins that are used to form channels to accommodate the sensor wires. These shaping arbors can be difficult to make and can be expensive due to the close tolerances required.

Being able to adapt an insulator having complex geometries, without using special shaping arbors, may save significant time and cost. Condition sensing spark plugs in particular, such as automotive thermocouple spark plugs, can be important tools for understanding engine performance, diagnosing engine problems, and developing an appropriate spark plug and spark plug firing conditions for particular engine types. It should be understood that the methods herein may be used to make insulators for any type of condition sensing spark plug that requires wires, leads, or other sensor components embedded or extending within the insulator. Condition sensing spark plugs may include but are not limited to pressure sensing spark plugs, gas composition sensing spark plugs, or temperature sensing spark plugs such as thermocouple spark plugs, to cite a few examples. Although the following description is provided in the context of an automotive thermocouple spark plug, it should be appreciated that the insulator and method described herein may be used with any type of spark plug or ignition device, including glow plugs, industrial plugs, aviation igniters and/or any other device that is used to ignite an air/fuel mixture in an engine. The teachings herein are not exclusive to insulators used in condition sensing spark plugs. Moreover, the teachings herein are not exclusive for the other insulator configurations described herein, such as those having a dual barrel, and one or more internal wells toward the firing end and/or toward the terminal end.

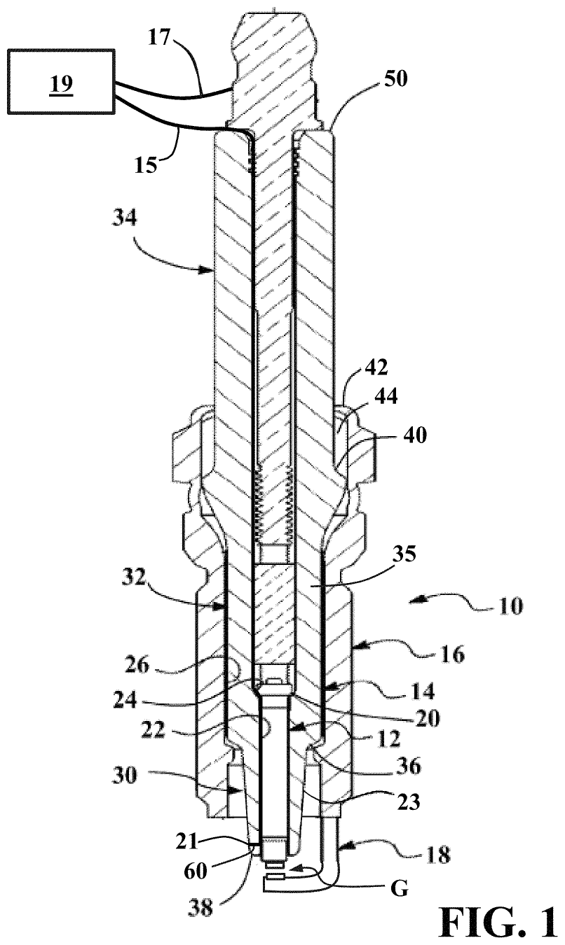

An example condition sensing spark plug is shown in FIG. 1, where the spark plug includes a sensing device for measuring various engine conditions. The spark plug 10 includes a center electrode 12, an insulator 14, a metallic shell 16, and a ground electrode 18. The insulator 14 is manufactured in accordance with the methods described herein to have channels for receiving wiring 15, 17 for a sensing, display, or processing device 19. The center electrode 12, which can be a single unitary component or can include a number of separate components, is at least partially disposed or located within an axial bore 22 that extends along the axial length of the insulator 14. As illustrated, the axial bore 22 includes one or more internal step portions 24 that circumferentially extend around the inside of the bore and are designed to receive complementary external step portions 20 of the center electrode 12. In the embodiment of FIG. 1, the axial bore 22 only includes a single internal step or shoulder portion 24; however, it is possible for the axial bore to include additional internal step portions at different axial positions along the length of the bore. The insulator 14 is at least partially disposed within an internal bore 26 of the metallic shell 16, and the internal bore 26 extends along the length of the metallic shell and is generally coaxial with the axial bore 22. In the particular embodiment shown, a tip end of the insulator 14 extends from and protrudes beyond the end of the metallic shell internal bore 26, and a tip end of the center electrode 12 extends from and protrudes beyond the insulator axial bore 22. The tip end of the center electrode 12 forms a spark gap G with a corresponding portion of the ground electrode 18; this may include embodiments with or without precious metal firing elements on the center electrode and/or the ground electrode. In the FIG. 1 embodiment, both the center and ground electrodes 12, 18 have precious metal firing elements attached thereto, but the disclosed spark plug arrangement is simply provided as an example and is not required.

The insulator 14 is an elongated and generally cylindrical component that is made from an electrically insulating material and is designed to isolate the center electrode 12 from the metallic shell 16 so that high-voltage ignition pulses in the center electrode are directed to the spark gap G. The insulator 14 includes an axial bore 22 and an outer surface 23. Along its length, the insulator 14 includes a nose portion 30, an intermediate portion 32, and a terminal portion 34. The insulator 14 comprises a ceramic body 35 that has a very fine microstructure and low porosity, lower than insulators produced in other ways, such as dry pressing, to cite an example. The microstructure is photopolymerized and sintered to create this low porosity. Other configurations or embodiments are certainly possible, beyond those illustrated in the figures, and will likely be at least partially dictated by the desired application for the spark plug 10.

The nose portion 30 extends in the axial or longitudinal direction between an external step 36 on the outer surface 23 of the insulator and a distal end 38 located at a tip of the insulator 14 at the firing end of the plug 10. The outer surface 23 may include other structural features not shown in FIG. 1 such as an annular rib to limit or prevent carbon fouling and other build-up. The nose portion 30 may have a continuous and uniform taper along its axial extent, or it could have sections of differing taper or no taper at all (i.e., straight sections where the outer surfaces are parallel to one another). Moreover, the extent to which the nose portion 30 axially extends or protrudes beyond the end of the metallic shell 16 (sometimes referred to as the “projection”), may be greater or less than that shown in FIG. 1. In some cases, it is even possible for the distal end or tip 38 of the nose portion to be retracted within the insulator bore 22 so that it does not extend beyond metallic shell at all (i.e., a negative reach).

The intermediate portion 32 of the insulator extends in the axial direction between an external locking feature 40 and the external step 36 described above. In the particular embodiment illustrated in FIG. 1, the majority of the intermediate portion 32 is located and retained within the internal bore 26 of the metallic shell 16. The external locking feature 40 may have a diametrically-enlarged shape so that during a spark plug assembly process, an open end or flange 42 of the metallic shell can be folded over or otherwise mechanically deformed in order to securely retain the insulator 14 in place. The folded flange 42 also traps an annular seal or gasket 44 in between an exterior surface of the insulator 14 and an interior surface of the metallic shell 16 so that a certain amount of sealing is achieved. In another embodiment, the annular seal 44 can be omitted so that the folded flange 42 is in direct contact with the external locking feature 40. Other intermediate portion features are certainly possible as well.

The terminal portion 34 is at the opposite end of the insulator as the nose portion 30 and it extends in the axial direction between the external locking feature 40 and a second distal end or terminal end 50. In the illustrated embodiment, the terminal portion 34 is quite long, however, it may be shorter and/or have any number of other features, like annular ribs. During operation, the terminal portion 34 is generally situated outside of the combustion chamber of the engine.

Wires 15, 17 at least partially extend along the length of the axial bore 22 of the insulator 14 from the terminal portion 34 so that they end at or near the distal end 38 of the nose portion 30, and can accordingly sense various engine conditions such as temperature. It should be noted that the insulator channel for wire 17 is not shown in FIG. 1 as it is situated behind other spark plug components. In the illustrated embodiment, the wires 15, 17 join at a junction region 21 on the outer surface 23 of the nose portion 30 of the spark plug insulator, but such an arrangement is merely an example. Wires 15, 17 are shown as part of an example thermocouple spark plug 10 and are connected to a sensing device 19; however, it should be understood that there may be only one wire, lead, or other sensor component in the axial bore of the adapted insulator, or there may be more than two wires, leads, or other sensor components. Further, the sensor and/or the sensing device may be a pressure sensor, a gas composition sensor, or any other sensor or device that may be beneficial for sensing engine conditions. Skilled artisans will appreciate that there may be any number and/or combination of wires, leads, or other sensor components that may be compatible with numerous types of sensors. Moreover, the particular ending point of wires, leads, or sensor components may vary. For example, channels may be formed along any portion of the insulator or extend the entire axial length of the insulator, as will be described in more detail below, yet still fall within the scope of the described methodologies. In other embodiments, the spark plug may not be a condition sensing spark plug at all, so there may be no wires or channels in the insulator to accommodate wires.

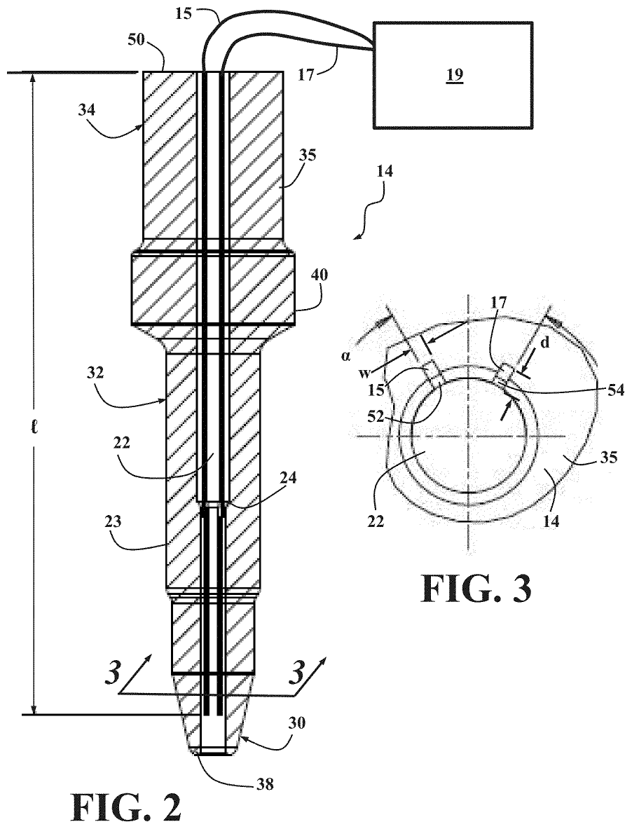

With reference to FIG. 2, there is shown a cross-section of the insulator 14 taken along an angle so as to reveal the channels for wires 15, 17 which are angularly spaced around the axial bore 60° from one another. Wires 15, 17 extend an axial length l of the axial bore 22 of the insulator 14. It should be understood that the axial length l is variable, and accordingly, the wires may end at variable locations along the axial bore of the insulator. Moreover, the wires may be fully or partially embedded into the insulator. For example, a potting compound can be used to electrically isolate the wires from the center electrode. In another example, the channels may be wholly embedded as a result of the manufacturing methods described herein, to create one or more additional axially extending bores in the ceramic body 35.

With reference to FIG. 3, which is a partial, cross-sectional view of the insulator 14 shown in FIG. 2 taken along line 3-3, it is shown that the wires 15, 17 are separated by angle α. In a preferred embodiment, angle α is 60°; however, other angular orientations are certainly possible. The wires 15, 17 are accommodated in channels 52, 54, respectively. Channels 52, 54 may have a depth d that extends radially from the axial bore 22 toward the outer surface 23 of the insulator 14. In a preferred embodiment, the depth d is approximately 0.5 mm. Channels 52, 54 may further include a width w that extends along the circumference of the axial bore 22. In a preferred embodiment, the width w is approximately 0.5 mm. However, the channels 52, 54 may be sized and shaped differently in order to accommodate any number of different wires.

The channels 52, 54 generally extend into the body 35, along the internal surface of the axial bore 22 of the insulator 14, from the second distal end 50 of the terminal portion 34 toward the first distal end 38 of the nose portion 30. The channels may have variable depths or widths, depending on the size of the wire, lead, or other sensor component, or based upon the degree of radial embeddedness that is desired. Similarly, the depth of the channels 52, 54 may differ between the portions on either side of the shoulder 24, or it may be consistent between the portions on either side of the shoulder 24. It should be understood that there can be one channel, two channels as depicted in the figures, or more than two channels. The method described below is not limited to a particular number, configuration, or type of insulator feature, and in some embodiments, any channel orientation, location, or structure, is certainly possible.

The channels 52, 54 partially extend along the length of the axial bore 22 to a location near the distal end 38 of the nose portion 30. Radial passageways 60, 62 on either end of the joining region 21 are formed in the insulator 14 to allow the wires to join at the outer surface 23 of the insulator (see e.g., FIG. 9 for the location of both radial passageways 60, 62 with respect to the outer surface 23 of the insulator 14). In a preferred embodiment, the radial passageways are situated 1-2 mm from the distal end 38 of the nose portion 30, but this can vary. Radial passageways 60, 62 generally define the junction region 21 for the wires of the condition sensing spark plug. A groove 64 in the outer surface 23 of the insulator forms the junction region 21. The groove 64 is optional, and it may be used to help shield the wires, leads, or other sensor components from the harsh conditions of the combustion chamber.

Radial passageways 60, 62 are optional. If, for example, the channels extend the entire length of the axial bore of the insulator, it may not be necessary to include radial passageways as the wires would simply extend from the axial bore opening at the distal end 38. Similarly, if the sensing wires, leads, or other components only need to be near the combustion chamber, radial passageways may not be necessary. The presence, absence, structure, and/or size of radial passageways will vary depending on the type of sensor and its various components. The method described herein is meant to be adaptable to any spark plug insulator, and is particular well suited to spark plug insulators having detailed features, such as the channels and radial passageways described herein, to cite a few examples.

With particular automotive thermocouple spark plugs, such as the spark plug 10 illustrated in FIG. 1, wires 15, 17 extend from the second distal end 50 of the terminal portion 34 toward the first distal end 38 of the nose portion 30, meeting at the junction region 21 on the outer surface 23 of the adapted insulator 14. Once the wires and thermocouple bead or junction are in place at the junction region 21, a potting compound may be used to fill the groove 64 in order to isolate the wires from the engine environment. This may be accomplished with an alumina based potting compound applied in such a way that only the bead or junction of the thermocouple remains exposed.

It should be noted that the example embodiments shown in the figures and described above are only meant to serve as examples of insulators that are made according to the process taught herein, as the process may be used to make other insulator embodiments, including those that differ significantly from insulator 14 or the other insulator embodiments depicted in the figures. Furthermore, spark plug 10 is not limited to the displayed embodiments and may utilize any combination of other known spark plug components, such as terminal studs, internal resistors, internal seals, various gaskets, precious metal elements, etc., to cite a few of the possibilities. Spark plug 10 may similarly include any combination of other sensing components or devices, or no sensing devices at all, and is not limited to the illustrated embodiments provided. Moreover, the insulator may have different configurations, and may include other insulative components (e.g., an additional ceramic chamber or component piece).

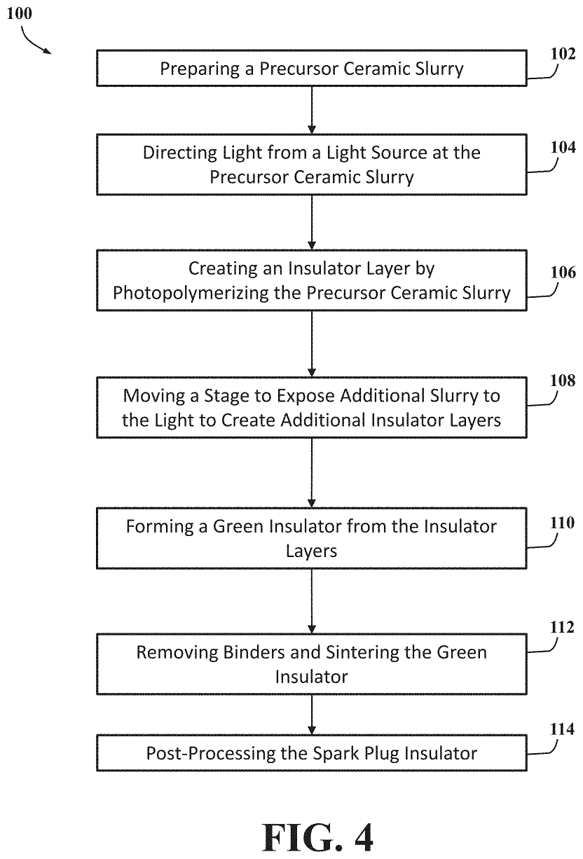

FIG. 4 is a flowchart that illustrates an exemplary process 100 for making a spark plug insulator, such as the insulator 14 for the condition sensing spark plug 10 or the other insulator embodiments shown in the figures. Step 102 of the method involves preparing a precursor ceramic slurry. In a preferred embodiment, the precursor ceramic slurry includes alumina-based ceramic particles, including but not limited to any of the examples set forth in U.S. Pat. No. 7,169,723, which is hereby incorporated by reference in its entirety. Other ceramic compositions are certainly possible. Ceramic powder is mixed with organic resins, and in a more particular embodiment, is mixed with photopolymerizable organic resins. The precursor ceramic slurry may include the ceramic powder, organic resins, an organic or other solvent, and a photoinitiator such as a UV photoinitiator, although other photoinitiator types are possible and will depend on the type of light source used later in the method. Other constituents in the precursor ceramic slurry are certainly possible.

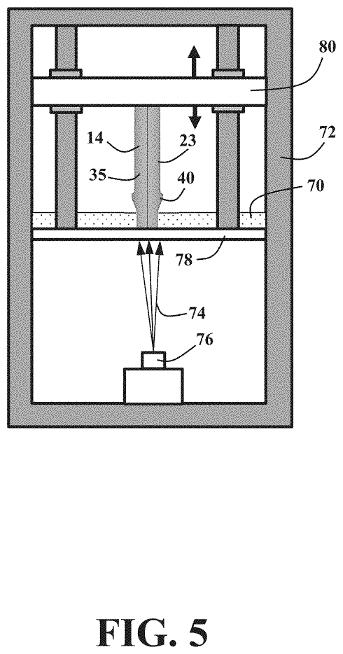

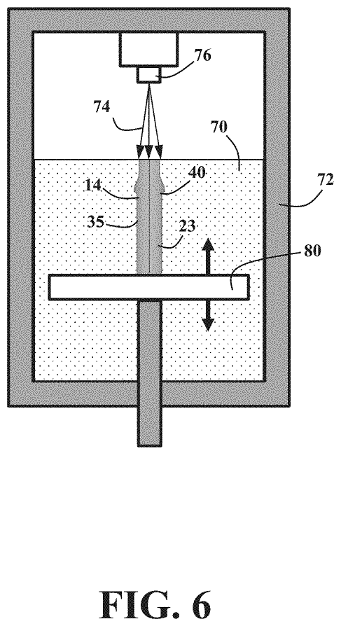

Step 104 of the method 100 involves directing light from a light source at the precursor ceramic slurry. Two potential embodiments of this method step are schematically illustrated in FIGS. 5 and 6. With reference to FIG. 5, the precursor ceramic slurry 70 from step 102 is held in a tank 72. Light 74 from light source 76, which is advantageously a laser light source in some embodiments, is directed to a transparent or translucent plate 78 located beneath the ceramic slurry 70. The plate 78 allows the transmission of light 74 therethrough such that it impacts the precursor ceramic slurry 70. In FIG. 6, light 74 from the light source 76 is shone directly at the precursor ceramic slurry 70. In this embodiment, the light source 76 is situated above the slurry 70 in the tank 72. Other arrangements for the light source 76 and tank 72 are certainly possible.

Step 106 of the method 100 involves creating an insulator layer by photopolymerizing the precursor ceramic slurry 70. In one embodiment, a computer controlled 3D printing machine is used with the slurry tank 72, the laser light source 76, and a movable stage 80. This step may take place using stereolithography, selective laser sintering, or some other printing technique. Advantageously, a stereolithographic process is used to create each insulator layer. In this embodiment, computer software controls the movable stage 80 and the laser 76 in such a manner that the laser light 74 causes layer-by-layer polymerization of the resin by rastering across the surface of the slurry 70 as the stage 80 is incrementally moved. In another embodiment, the light 74 is projected on the surface of the slurry 70 as an image instead of rastering a single spot of light.

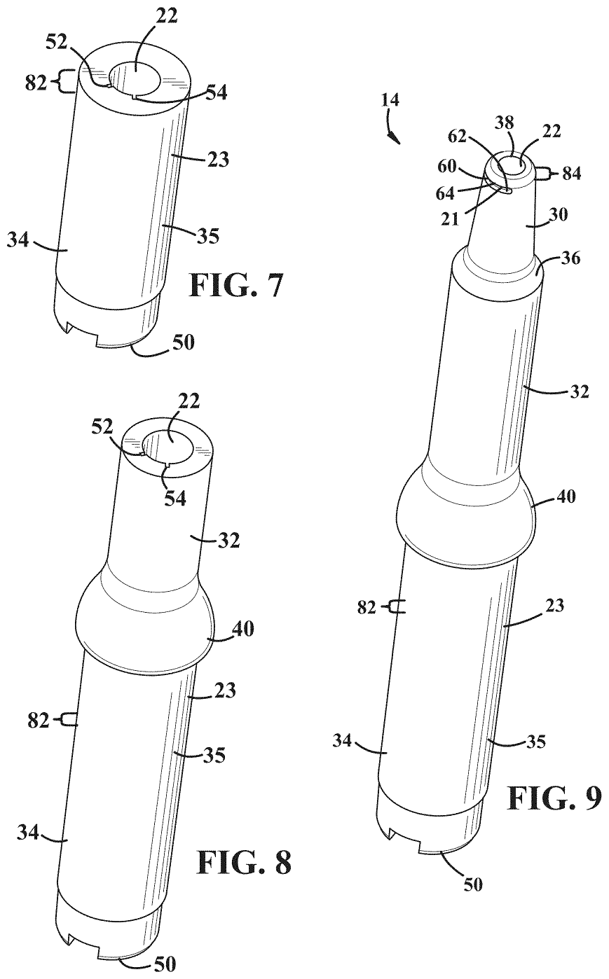

An insulator layer 82 is schematically represented in FIG. 7. In FIG. 7, the insulator 14 is only 40% completed; in FIG. 8, the insulator is 70% completed; and in FIG. 9, the insulator is 100% completed and contains all of the insulator layers, including another schematically illustrated insulator layer 84. In each of the insulator layers, the ceramic body 35 having a photopolymerized and sintered microstructure surrounds an axial bore 22. In the insulator layer 82, for example, there are two channels 52, 54 which are used to accommodate wires 15, 17 of the condition sensing spark plug 10. In the insulator layer 84, there are two radial passageways 60, 62 which connect the channels 52, 54 and the outer surface 23. In accordance with typical manufacturing methods, the channels 52, 54 are formed with special pressing arbors, a method that can increase cost and manufacturing time, and the radial passageways 60, 62 are drilled or otherwise machined into the insulator. These methods can result in undesirable breakage, whereas with the current method, these detailed features 52, 54, 60, 62 are formed in situ during the formation of each insulator layer 82, 84 of the green ceramic body 35. With the present method 100, a wider geometric range for the various features is possible, because, for example, the geometry is not limited by requirements such as removing a pressing arbor from the unfired insulator. The size of each layer 82, 84 is not necessarily to scale in the figures, and will likely depend on the setup of the tank 72, the laser 76, and the composition of the slurry 70.

Returning to FIGS. 5 and 6, in step 108, the stage 80 is moved to expose additional precursor ceramic slurry 70 to the light 74 to create additional insulator layers. In FIG. 5, the slurry tank 72 includes an optically transparent bottom 78, a moveable stage 80 and a light source 76. The light source 76 projects light 74 through the transparent bottom 78 of the tank 72. The light 74 polymerizes the resin in the precursor ceramic slurry 70 causing the slurry to solidify. The stage 80 is raised and the slurry 70 forms a thin layer between the partially formed part and the transparent bottom 78 of the slurry tank 72. Light 74 is then projected against this thin slurry layer to solidify form a new insulator layer, such as the layers 82, 84. In FIG. 6, the stage 80 is lowered and the slurry 70 forms a thin layer over the top of the solidified part, instead of on the bottom as shown in FIG. 5. However, like FIG. 5, the light 74 is projected on the surface causing another insulator layer to be solidified. The process is repeated in both embodiments until the green insulator 14 is formed, as shown in FIG. 9.

Step 110 involves forming a green or unfired insulator 14, as shown in FIG. 9 for example, from the insulator layers, such as insulator layers 82, 84. The shape of the green insulator 14 is generally dictated by the shape of a 3D model input to the 3D printing device, which also takes into account further densification that occurs during a sintering/binder removal process. One advantage of the present method is the ability to more precisely form features in the outer surface 23 such as the external step 36 and/or the external locking feature 40. Another advantage of the present method is the ability to more precisely form features in the axial bore 22, which are detailed further below. When the light 74 from the laser 76 polymerizes the slurry 70, the light scatters and a spherical volume can buildup sideways to help achieve the structure of the overhangs such as external step 36 and/or external locking feature 40. Once the green insulator 14 is formed, including the features in the axial bore 22 described above, as well as features in the outer surface 23, the green insulator needs to be separated from the un-polymerized slurry 70. Additionally, in this step, the green insulator 14 can be cleaned to remove excess slurry 70.

In step 112, binders are removed from the green insulator 14. In one embodiment, the green insulator 14 is heat treated to remove organic resin; although other removal methods are possible, such as chemically removing the binders. A heat treatment process such as sintering can advantageously be used to both remove the photopolymerized binders, and during the heat treatment process, the green insulator 14 can be sintered to its final density. In some embodiments, separate heat treatments are used to first remove any resins or binders and then to fully densify the insulator. In other embodiments, one high heat sintering process is used to both remove resins and binders while sufficiently densifying the photopolymerized ceramic body 35. Advantageously, the insulator 14 is sintered to create a monolithic ceramic body 35. To create the photopolymerized and sintered microstructure, the sintered ceramic should contain less than 5% porosity, preferably less than 3% porosity, and most preferably less than 2% porosity.

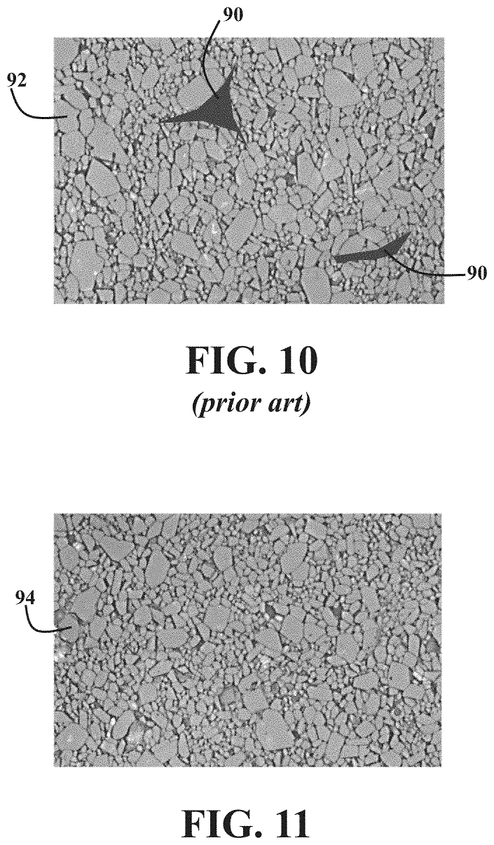

Typically, most additive manufacturing methods used for ceramics were unable to make a ceramic body 35 with sufficient density and sufficiently free from pores to withstand the high voltages required for a spark plug, such as the spark plug 10. Because the insulators 14 are prepared directly from the ceramic slurry 70 without the intermediate steps of spray drying and pressing that are more typically used for thermocouple insulators, process-related defects such as pressing voids and relics of spray dried particles are not present in the insulators 14 made according to the method 100. FIG. 10 schematically illustrates the pressing relics 90 which are present in the microstructure 92 of insulators made through a pressing process, such as dry-bag isostatic pressing, which involves high-pressure shaping of the powder-based ceramic materials. These relics 90 are absent from the microstructure of the insulator 14, as shown in the photopolymerized and sintered microstructure 94 of an insulator made in accordance with the method 100. The relics 90 are typically about 3-4 times larger (or even larger) than the average size of gaps between grains in the microstructure 92.

Step 114 is optional and involves post-processing of the spark plug insulator 14. Advantageously, after heat treatment in step 112, the insulator 14 is fully formed and requires no additional machining, processing, etc. However, it is possible in some embodiments to conduct other shaping, grinding, lapping, polishing, marking, glazing, or other ceramic-related forming processes during step 114. Some of these additional steps may occur before and/or after sintering in step 112. The insulator 14 can then assembled into a spark plug, such as the condition sensing spark plug 10.

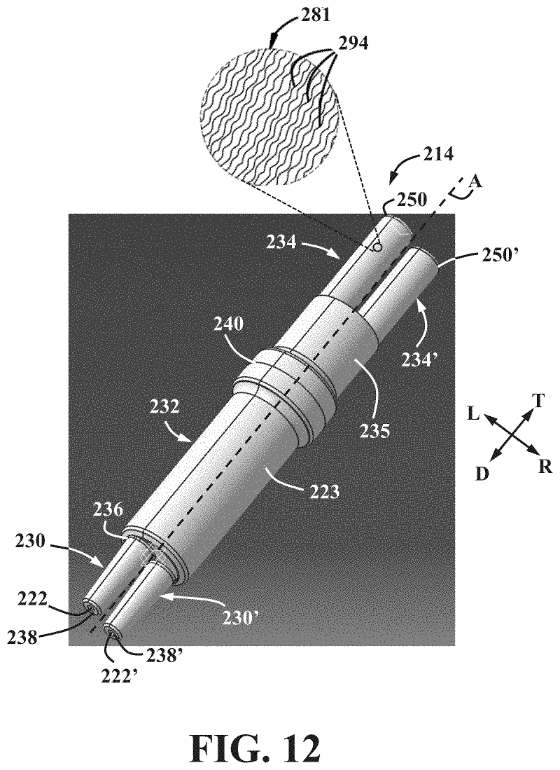

FIG. 12 illustrates another embodiment of an insulator 214 that can be manufactured in accordance with the method 100 described herein (like reference numerals denote like structure with respect to the embodiments illustrated in FIGS. 12-16). The insulator 214 includes a first axial bore 222 and a second axial bore 222′. The dual-barrel configuration of the insulator 214 having both axial bores 222, 222′ can be advantageously used in a spark plug having two terminal connections and two firing electrode assemblies. Typically, spark plug insulators are limited to axisymmetric geometry due to limitations on manufacturing. Use of an extrusion process or a dry bag isostatic pressing process, may require a pressing arbor to form an insulator with a complex geometry. Injection molding may also be used, but such tooling may be costly and can require a long lead time to develop. Instead, the complex, non-axisymmetric geometry of the ceramic body 235 in the insulator 214 can be 3D printed in accordance with the method 100.

The spark plug insulator 214 depicted in FIG. 12 has two axial bores 222, 222′ and the outer surface 223 can be particularly configured to structurally accommodate other portions of a dual barrel spark plug. For example, the insulator 214 has first and second nose portions 230, 230′, a common intermediate portion 232, and first and second terminal portions 234, 234′. Having a structurally common intermediate portion 232 may provide for better nesting within the internal bore of the spark plug shell, while having structurally distinct nose portions 230, 230′ can allow for advantageous structural adaptations. For example, one nose portion may be manufactured so that it is longer than the other nose portion. This may be beneficial in embodiments in which one firing end is encased in a prechamber cap and one firing end is a more standard gap without a prechamber cap. Other structural adaptations are certainly possible. With two structurally distinct and separated nose portions 230, 230′ and terminal portions 234, 234′ the gap between each respective portion is preferably greater than 0.26 mm to avoid bridging, and no larger than the amount of space required such that each portion is located fully within the diameter of the common intermediate portion 232.

FIG. 12 also includes a schematic view of the anisotropic nature of the microstructure 294, which includes a plurality of layers 281. The anisotropic microstructure 294 and layers 281 are only schematically illustrated in FIG. 12, and are not necessarily to scale. The layers 281 can be built in different orientations or directions to impact structural properties of the insulator 214, or to enhance manufacture, for example. It should be noted, however, that sintering after photopolymerization can impact or lessen the stratified nature of the microstructure 294 and thereby impact the corresponding anisotropic structural properties. In one example of exploiting the anisotropic structural properties, the layers 281 are printed so that they are substantially perpendicular to the axis A of the insulator 214 (the axis A is the longitudinal axis located at the center of the insulator and extends between each end 238, 250). This may be easier to manufacture. The layers 281 may be built to increase strength in a particular force direction. For example, with the anisotropic microstructure 294, properties such as the tensile strength and break elongation can be comparatively better with respect to a force direction that is perpendicular to the direction in which the plurality of layers 281 are built. Thus, in some embodiments, it may desirable to have the plurality of layers 281 built in a substantially longitudinal direction or a substantially transverse direction to impart strength in a particular force direction. In the FIG. 12 embodiment, the plurality of layers 281 are built in a direction so that the layers are substantially parallel to the axis A. “Substantially,” as used herein, to indicate the directional build of the microstructure 294 in this example, means a variation from the direction in the designated coordinate system (T/D, L/R, I/O, with in/out (I/O) being into and out of the page) that is less than or equal to 20° in either direction. With respect to FIG. 12, the plurality of layers 281 are built in a substantially longitudinal direction that is parallel with the axis A, which can help improve the strength the core nose portions 230, 230′ to an incoming side force in the combustion chamber. As detailed further with respect to the insulator 14, in other embodiments, the plurality of layers 281 can be built in another direction, such as a substantially transverse direction, which can help improve the strength of the insulator in the T/D direction. With either direction, the dielectric strength of the insulator 14, 214 as a whole can be improved as compared with insulators manufactured with conventional processes.

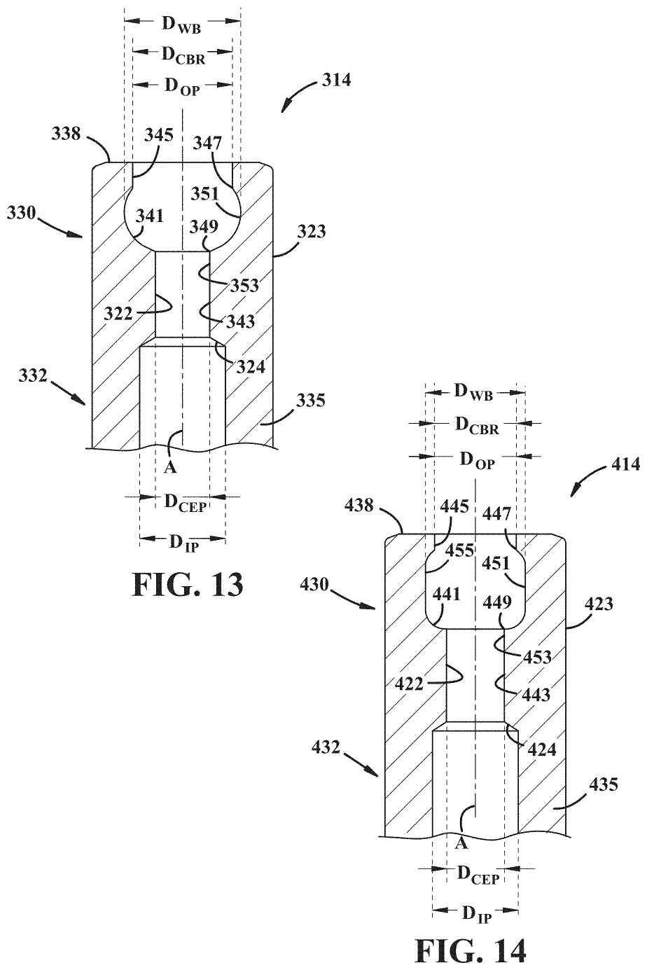

FIGS. 13-16 illustrate insulator embodiments having one or more internal wells located in the nose portion of the axial bore near the firing or distal end. It is possible in other embodiments as well to locate one or more internal wells near the terminal end or at other locations along the axial bore. The complex geometries described herein include non-axial symmetric die-lock geometries (e.g., a thread or other shape that may be difficult to remove from a standard mold or the like). FIG. 13 includes an internal well 341 located within the axial bore 322 near the distal end 338. While the discussion herein is focused primarily on the internal well 341, features of the internal well 341 may also be applicable to the other internal well embodiments 441, 541, 641 unless otherwise incompatible, and vice versa, and other structural adaptations besides those explicitly shown and described herein may be made (e.g., a conical taper on the outer surface 323). The internal well 341 helps to increase the flashover distance from the shell to the center electrode. Carbon fouling can occur when combustion deposits form on the surface of the insulator 314 (e.g., the outer surface 323 and/or the internal surface 343 of the axial bore 322). These deposits can cause the surface to become more electrically conductive and the spark then travels along the surface instead of across the spark gap.

The complex geometry of the internal well 341 is advantageously formed via the process 100, as conventional processes can typically only form wells in which the diameter at the opening portion 345 in the axial bore 322 at the distal end 338 is larger than or equal to any other point in the well or in the axial bore between the distal end and the internal step portion 324 (the nose portion 330). Such methods include machining the well, pressing around an arbor to form the well, or injection molding the insulator having the well. It can be desirable, however, to more efficiently impart one or more complex geometric shapes to the axial bore 322 to at least partially control the plug's carbon fouling response in a more strategic fashion. For example, the well configurations disclosed herein can increase the flashover length at strategic areas in the axial bore as compared to a well that is a straight cylinder or a cylinder with a slight taper.

The axial bore 322 at the core nose portion 330 begins with an opening portion 345 on the inner surface 343 of the axial bore 322 that is directly adjacent to (and in some embodiments, substantially orthogonal with respect to) the distal end 338 of the insulator 314. Two features that are directly adjacent to each other do not have another functional structure between them (e.g., they are situated directly next to each other), whereas features that are described as being adjacent to each other may have one or more functional structures between them. The opening portion 345 in the illustrated embodiments is a straight, circular cylindrical wall, but it is possible to have other configurations, such as a tapered or angled wall.

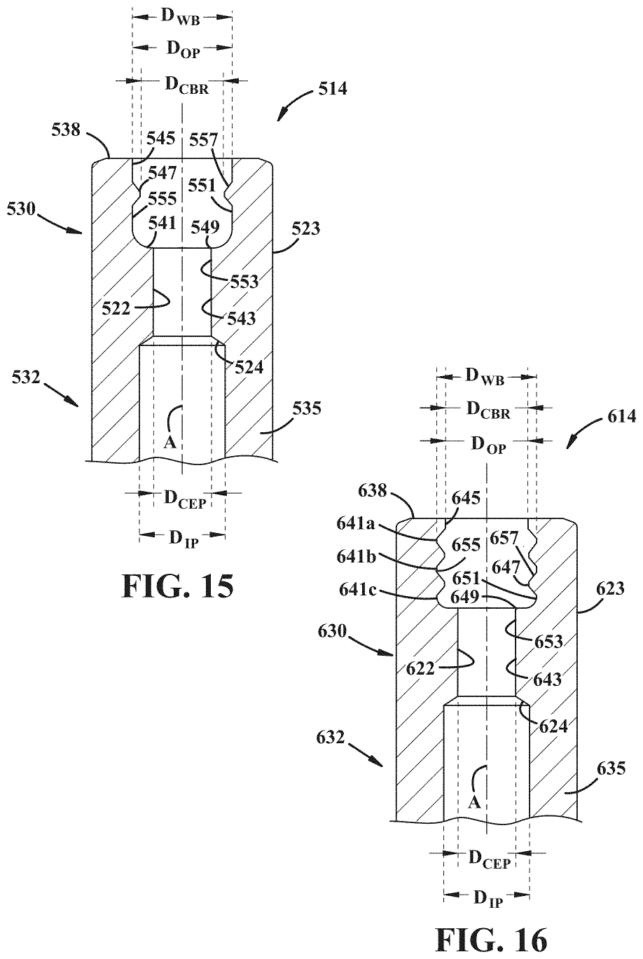

The opening portion 345 is directly adjacent to the internal well 341. The internal well 341 is generally defined by a ceramic bounding ring 347 and a terminal end 349 with a well base 351 located therebetween. The ceramic bounding ring 347 is situated such that it is the start or tip of the internal well 341 at the opening portion 345. Accordingly, the ceramic bounding ring 347 can have an angled, pointed, or rounded corner shape. The ceramic bounding ring 347 has a diameter D_{CBR} that is diametrically smaller or less than a diameter D_{WB} of the well base 351. In the FIG. 13 embodiment, the diameter of the ceramic bounding ring D_{CBR} is equal to the diameter of the opening portion D_{OP}. However, it is possible for the diameter of the ceramic bounding ring D_{CBR} to be less than the diameter of the opening portion D_{OP} (see e.g., FIG. 15). The smaller diameter D_{CBR} of the ceramic bounding ring 347 helps shield the well base 351 from line-of-sight deposition of combustion deposits. This can also help improve plug performance over time.

The well base 351 and the diameter D_{WB} of the well base is defined by the widest portion of the internal well 341 (i.e., the point between the ceramic bounding ring 347 and the terminal end 349 at which there is the greatest radial distance from the axis A to the inner surface 343 of the bore 322). The diameter D_{WB} of the well base 351 is advantageously located at a portion along the inner surface 343 where carbon fouling is more prone to occur, and this may depend at least partially on the position of the center electrode within the bore 322.

In FIG. 13, the internal well 341 has a spherical geometry. Accordingly, there is a continually variable radius or distance between the inner surface 343 and the axis A between the ceramic bounding ring 347 and the terminal end 349 of the well. This creates a configuration for the well 341 in which the well base 351 is in a more specific or concentrated location, as compared with wells such as the well 441 in FIG. 14 in which the well base 451 is a longer portion of the inner surface 443. Having a the well base 351 in a more specific or concentrated location as shown in FIG. 13 can help reduce the amount of line-of-sight deposits on a portion of the internal well 341 that is closer to the distal end 338.

The terminal end 349 of the internal well 341 is directly adjacent a diametrically reduced center electrode shield portion 353. The terminal end 349 is situated such that it is the end or tip of the internal well 341 at the center electrode shield portion 353. Accordingly, the terminal end 349 can have an angled, pointed, or rounded corner shape. The diameter D_{CEP} at the terminal end 349 or at the center electrode shield portion 353 is less than each of the diameters D_{WB}, D_{CBR}, and D_{OP}. This smaller diameter D_{CEP} can help better accommodate or nest the center electrode. The center electrode shield portion 353 is an elongated, circular cylindrical portion of the inner surface 343 of the axial bore 322. This portion has a generally constant radius between the inner surface 343 and the axis A. The center electrode shield portion 353 is directly adjacent to the internal step portion 324, which seats the center electrode (see e.g., FIG. 1 for illustration on how the internal step portion seats the center electrode). The internal step portion 324 is the portion of the axial bore 322 which divides the nose portion 330 from the intermediate portion 332. The internal step portion 324 extends at an angle from the center electrode shield portion 353 to the intermediate portion 332. This angle may be substantially equal to the angle at which the internal wall 341 extends radially outwardly from the center electrode shield portion 353. The diameter D_{CEP} is thus smaller than the diameter of the intermediate portion D_{IP} to help create the internal step portion 324.

FIGS. 14-16 illustrate example configurational variations for the internal well 441, 541, 641a-c, respectively. In FIG. 14, the well base 451 has a planar section 455 in which the distance or radius between the inner surface 443 and the axis A is generally consistent for a majority of the area of the well 441. Thus, this well 441 has more of a circular cylindrical complex geometry. This consistency in shape can be easier to manufacture in some instances, for example, when a certain type of alumina or ceramic composition dictates different thickness tolerances.

In FIG. 15, the diameter D_{CBR} of the ceramic bounding ring 547 of the well 541 is smaller than the diameter D_{OP} of the opening portion 545. This creates a ceramic bounding ring 547 which has a rib structure along the inner surface 543 of the bore 522. This projecting rib type ceramic bounding ring 547 has an additional shielding surface 557 resulting from the particular diametrical variation in the bore 522. This additional shielding surface 557 can further shield the well 541 from line-of-sight deposits.

FIG. 16 illustrates an embodiment in which the nose portion 630, between the opening portion 645 and the center electrode shield portion 653, has a plurality of internal wells 641a, 641b, 641c. Having a plurality of internal wells 641a-c creates an undulating pattern on the inner surface 643 of the axial bore 622. This undulating pattern thus creates a plurality of crests and troughs, wherein each ceramic bounding ring 647 constitutes a crest and each well base 651 constitutes a trough (the subcomponents of the internal well 641 are labeled only once in FIG. 16 for clarity purposes). Further, this arrangement creates two or more shielding surfaces 657 via the multi-rib-type configuration, to help further control carbon fouling and create multiple, strategic deposition targets. The number of wells 641a-c may be three as shown, or in multi-well embodiments, may be two or more than three. Given the size constraints, it may be beneficial, as illustrated, to have a substantially orthogonal terminal end 649 at the well 641c that is directly adjacent the center electrode shield portion 653. This can create more room for each individual well 641a-c. Other dimensional and configurational variations are certainly possible. For example, the well configuration illustrated in FIG. 16, in particular, may be advantageously located at a recessed terminal end of an insulator, as the ribbed geometry of the axial bore can provide improved retention of a rubber boot.

It is to be understood that the foregoing is a description of one or more preferred example embodiments. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

1. A spark plug insulator comprising a ceramic body, wherein the ceramic body comprises:
an axial bore; and
a photopolymerized and sintered microstructure surrounding the axial bore.

2. The spark plug insulator of claim 1, wherein the ceramic body comprises:
a nose portion, an intermediate portion, a terminal portion, with the axial bore extending from a distal end at the nose portion to a terminal end; and
an internal well in the nose portion of the axial bore, wherein the internal well has a terminal end, a base, and a ceramic bounding ring, wherein the ceramic bounding ring is diametrically reduced with respect to a diameter at the base of the internal well, and wherein the ceramic bounding ring is situated between the terminal end of the internal well and the distal end at the nose portion.

3. The spark plug insulator of claim 2, wherein the internal well has a spherical geometry.

4. The spark plug insulator of claim 2, wherein the base of the internal well has a circular cylindrical geometry.

5. The spark plug insulator of claim 2, wherein the ceramic body includes a center electrode shield portion adjacent the internal well, wherein a diameter of the center electrode shield portion is less than or equal to the diameter at the base of the internal well.

6. The spark plug insulator of claim 5, wherein the ceramic body includes an internal step portion adjacent the center electrode shield portion, wherein the internal step portion separates the nose portion from the intermediate portion of the body, and the diameter of the center electrode shield portion is less than or equal to a diameter at the intermediate portion.

7. The spark plug insulator of claim 2, wherein the ceramic bounding ring is a projecting rib with a shielding surface.

8. The spark plug insulator of claim 2, further comprising one or more additional internal wells that create an undulating pattern with the internal well.

9. The spark plug insulator of claim 1, wherein the ceramic body has less than 2% by volume porosity.

10. The spark plug insulator of claim 1, wherein the photopolymerized and sintered microstructure has a plurality of layers built in a substantially longitudinal direction or a substantially transverse direction.

11. The spark plug insulator of claim 1, wherein the photopolymerized and sintered microstructure has a plurality of layers built in a direction that is substantially perpendicular to an axis A of the spark plug insulator.

12. The spark plug insulator of claim 1, wherein the ceramic body has a second axial bore, with each axial bore being configured to accommodate a center electrode.

13. The spark plug insulator of claim 1, wherein the ceramic body has one or more channels configured to accommodate one or more wires.

14. A spark plug insulator, comprising:
a body having a nose portion, an intermediate portion, and a terminal portion;
an axial bore extending through the body from a distal end at the nose portion to a terminal end at the terminal portion, the axial bore comprising:
an opening portion adjacent the distal end;
an internal well adjacent the opening portion, wherein the internal well has a ceramic bounding ring, a terminal end, and a base, and wherein the ceramic bounding ring is diametrically reduced with respect to a diameter at the base of the internal well, and wherein the ceramic bounding ring is situated between the terminal end of the internal well and the opening portion,
a center electrode shield portion adjacent the internal well, wherein a diameter of the center electrode shield portion is less than or equal to a diameter of the base of the internal well, and
an internal step portion adjacent the center electrode shield portion, wherein the internal step portion separates the nose portion from the intermediate portion of the body.

15. The spark plug insulator of claim 14, wherein the body is a ceramic body having a photopolymerized and sintered microstructure.

16. The spark plug insulator of claim 14, wherein the diameter of the center electrode shield portion is less than or equal to a diameter at the opening portion, and wherein the diameter of the center electrode shield portion is less than or equal to a diameter at the intermediate portion.

17. A method of making an insulator for a spark plug, comprising the steps of:
directing light from a light source at a precursor ceramic slurry; and
creating an insulator layer, wherein the insulator layer includes a portion of a photopolymerized ceramic body surrounding a portion of an axial bore.

18. The method of claim 17, further comprising the step of moving a stage to expose additional precursor ceramic slurry to the light source to create additional insulator layers.

19. The method of claim 17, wherein the light source is a laser, and the insulator layer includes a sideways spherical volume buildup to create an overhang.
